(19) United States
(12) Patent Application Publication
(10) Pub. No.: US 2022/0228600 A1
(43) Pub. Date: Jul. 21, 2022

(54) SOUND DAMPENING SCROLL FOR A FAN

(71) Applicant: Broan-NuTone LLC, Hartford, WI (US)

(72) Inventors: Anup Nikam, Hartford, WI (US); Timothy Heimerl, Hartford, WI (US)

(21) Appl. No.: 17/568,788

(22) Filed: Jan. 5, 2022

Related U.S. Application Data
(60) Provisional application No. 63/137,964, filed on Jan. 15, 2021.

(51) Int. Cl. F04D 29/42; F04D 25/08

(52) U.S. Cl. CPC F04D 29/4226; F05D 2260/96; F04D 25/08

(57) ABSTRACT

A scroll for a blower assembly includes a motor-mount plate, and a housing configured to be coupled to the motor-mount plate to define an interior blower cavity. The housing comprises inner and outer walls defining a cavity configured to dampen noise and vibrations produced by the blower assembly during operation.

### CROSS-REFERENCE TO RELATED APPLICATIONS

This application claims the benefit of U.S. Provisional Patent Application No. 63/137,964, filed on Jan. 15, 2021, which application is incorporated in its entirety herein by reference and made a part hereof.

### BRIEF DESCRIPTIONS OF THE DRAWINGS

The detailed description particularly refers to the accompanying figures in which:

FIG. 1 is an exploded assembly view of a scroll for a fan including a motor-mount plate and a sound-dampening housing; and

FIG. 2 is a perspective view of the sound-dampening housing with a section through line 2-2 in FIG. 1; and

FIG. 3 is a perspective view of the sound-dampening housing with a section through line 3-3 in FIG. 1.

### DETAILED DESCRIPTION

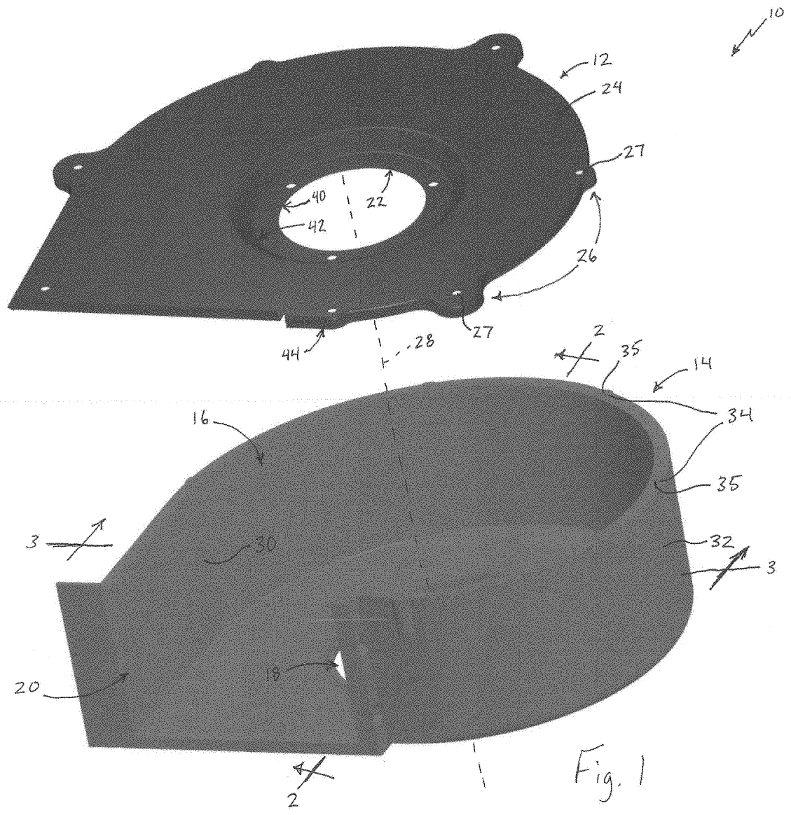

A scroll 10 for a blower assembly is shown in FIG. 1 and includes a motor-mount plate 12 and a sound-dampening housing 14. The motor-mount plate 12 and the sound-dampening housing 14 are configured to be coupled to one another and cooperate to define an interior blower cavity 16. The blower assembly also includes a motor (not shown) that is configured to be mounted to the motor-mount plate 12 and a wheel (also not shown). The wheel includes a plurality of fan blades that located within the interior blower cavity 16 and are rotated by the motor to move air through an inlet port 18 and discharge the air through and outlet port 20 such that the blower assembly can be used for ventilation purposes.

The motor and the plurality of fan blades may generate noises and vibrations during operation which may be audible to persons located near where the blower assembly is providing ventilation. The sound-dampening housing 14 is configured to dampen the noises and/or vibrations produced by the motor and the wheel and thereby reduce the total noise audible to nearby persons.

The motor-mount plate 12 is made from a rigid material, such as a metal, so that the motor-mount plate 12 provides sufficient strength to secure the motor and the wheel to the blower assembly. In other embodiments, the motor-mount plate 12 may be made from another suitable material, such as a plastic material or fiberglass. The motor-mount plate 12 includes a central motor mount 22, a peripheral cover 24, and a plurality of housing mounts 26 extend from the peripheral cover 24 as shown in FIG. 1. The central motor mount 22 is aligned with the inlet port 18 along an axis 28. The motor is configured to be mounted to the central motor mount 22 and the wheel is configured to rotate about the axis 28 during operation. The peripheral cover 24 extends from the central motor mount 22 radially outwardly away from the axis 28. Each of the plurality of housing mounts 26 is coupled to an outer edge of the peripheral cover 24 and is formed to include an aperture 27 that is sized to receive a fastener (not shown) to mount the motor-mount plate 12 to the sound-dampening housing 14.

The sound-dampening housing 14 includes an inner housing wall 30, an outer housing wall 32, and a plurality of mount posts 34 as shown in FIGS. 1-3. The inner housing wall 30 cooperates with the motor-mount plate 12 to define the interior blower cavity 16. The outer housing wall 32 is at least partially spaced apart from the inner housing wall 30 and the interior blower cavity 16 to define a cavity 36 between the inner housing wall 30 and the outer housing wall 32. The plurality of mount posts 34 are coupled to at least one of the inner housing wall 30 and the outer housing wall 32 and are formed to include fastener-receiving slots 35 that are aligned with the apertures 27 formed in the plurality of housing mounts 26 of the motor-mount plate 12 to also receive the fasteners (not shown) to secure the motor-mount plate 12 to the sound-dampening housing 14.

The sound-dampening housing 14 may be formed from a resilient material such as a plastic material that has greater sound dampening characteristics compared to other materials, such as metals, although the sound-dampening housing may be formed from a metal in some embodiments. The cavity 36 may be an empty space (i.e. air or a vacuum) or may include a sound-dampening media 38. The sound-dampening media 38 may be a gas, an insulative filler material, or a combination thereof. Some examples of insulative filler materials that may be used are a foam, a fiberglass web, or any other suitable filler material. The sound-dampening media 38 may fill the entirety of the cavity 36 or only one or more portions thereof. For example, the sound-dampening media 38 may include separate portions that are arranged in a pattern within the cavity 36. Additionally, the sound-dampening housing 14 may include a plurality of separate cavities 36 that are spaced apart from one another and located in select regions of the sound-dampening housing 14 where noise is the greatest, such as areas immediately surrounding the motor and/or the wheel.

In another embodiment, the motor-mount plate 12 may comprise inner and outer wall that are spaced apart from one another to define a sound-dampening cavity therebetween, similar to the cavity 36 defined in sound-dampening housing 14. If a metal material is used, the motor-mount plate 12 may be formed by a hydroforming process to shape the motor-mount plate 12 to include the central motor mount 22, the peripheral cover 24 and each of the housing mounts 26. Two separate metal parts may be formed to provide the inner and outer plates and they may be joined by spot welding or a clinching process. If a plastic material is used, the motor-mount plate 12 may be formed by blow molding, thermoforming, or by forming two separate plastic molded parts and subsequently joining the parts by soldering or an adhesive to combine them.

As shown in FIG. 1, the central motor mount 22 includes an inner mount flange 40 and a ramped outer flange 42 extending between the inner mount flange 40 and the peripheral cover 24. The inner mount flange 40 is offset inwardly from the peripheral cover 24 into the interior blower cavity 16. The peripheral cover 24 may be formed to include an outer rim 44 as its outer edge to fit around the sound-dampening housing 14 and form a better fit and seal therebetween.

The sound-dampening housing 14 may be formed to include the inner housing wall 30 and the outer housing wall 32 by blow molding, thermoforming, or by forming two separate plastic molded parts and subsequently joining the parts by soldering or an adhesive to combine them. If a metal material is used, the sound-dampening housing 14 may be formed by a hydroforming process or two separate metal parts may be formed to provide the inner and outer walls and then subsequently joined by spot welding or a clinching process.

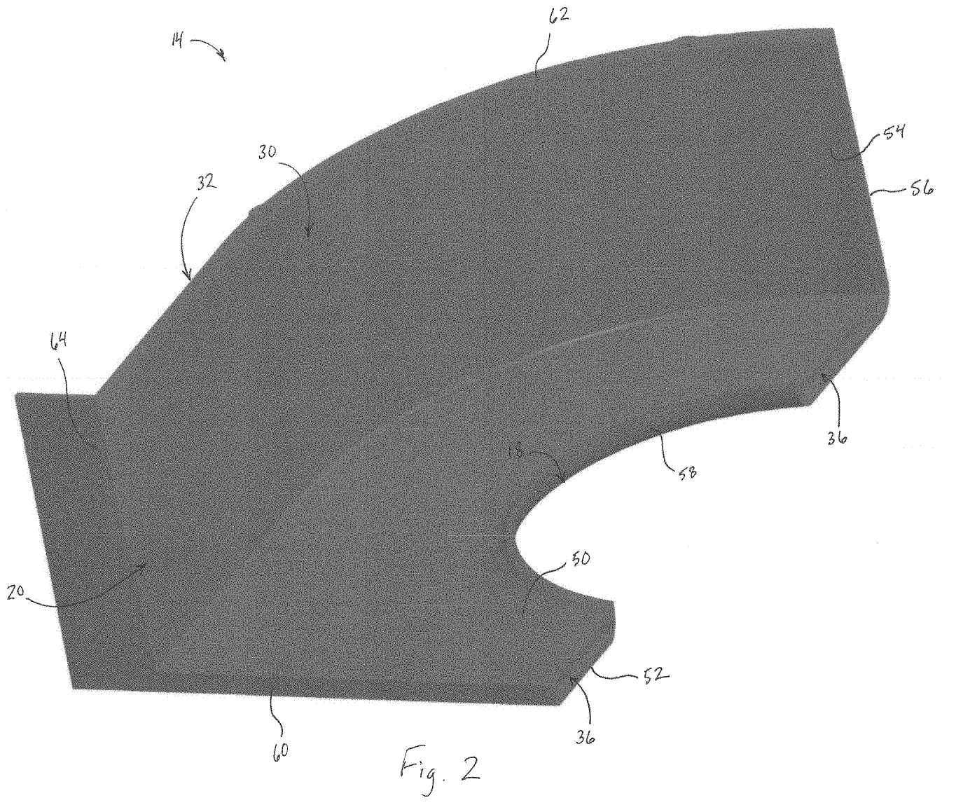

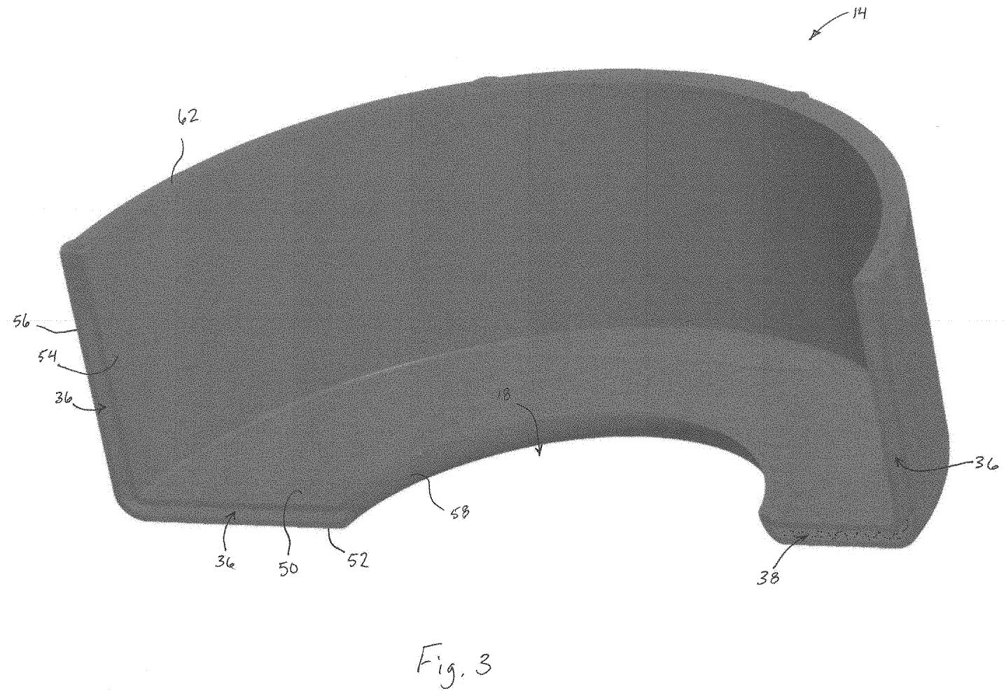

As shown in FIGS. 2 and 3, the inner wall 30 and the outer wall 32 each include a base panel 50, 52 and a sidewall panel 54, 56. The base panel 50 is coupled to the sidewall panel 54 to provide a seamless transition from base panel 50 to sidewall panel 54. The base panel 52 is coupled to the sidewall panel 56 to provide a seamless transition from base panel 52 to sidewall panel 56. The base panels 50, 52 are coupled to one another along an interior edge 58 defining the inlet port 18 and along an outlet edge 60 defining the outlet port 20. The sidewall panels are coupled to one another along an upper edge 62 where the motor-mount plate 12 is coupled to the sound-dampening housing 14 and along another outlet edge 64 also defining the outlet port 20. With this arrangement, the sound-dampening cavity 36 is continuous and uninterrupted by any parts of the base panels 50, 52 and the sidewall panels 54, 56 while also being fully enclosed by the base panels 50, 52 and the sidewall panels 54, 56.

A test was conducted to compare a prior art scroll housing (i.e. a single walled housing) to the sound-dampening housing 14 of the illustrative embodiment (i.e. double wall scroll). The results of the test are shown in Table 1 and Table 2, below, comparing some levels measured at set flow rates through each assembly in cubic-feet per minute (CFM) and with a static pressure of 0.1 and 0.25.

TABLE 1

| | Static Pressure 0.1 | | |
|---|---|---|---|
| | Single Wall | Double Wall | Sone |
| CFM | Scroll (Sone) | Scroll (Sone) | reduction |
| 100 | 1.097 | 0.925 | 16% |
| 80 | 0.613 | 0.486 | 21% |
| 50 | 0.145 | 0.094 | 35% |

TABLE 2

| | Static Pressure 0.25 | | |
|---|---|---|---|
| | Single Wall | Double Wall | Sone |
| CFM | Scroll | Scroll | reduction |
| 100 | 1.533 | 1.314 | 14% |
| 80 | 1.101 | 0.923 | 16% |
| 50 | 0.873 | 0.705 | 19% |

In some embodiments, the sound-dampening housing 14 of the illustrative embodiment provides a noise reduction within a range of about 14% to about 35% compared to a single wall scroll. In some embodiments, the sound-dampening housing 14 of the illustrative embodiment provides a noise reduction within a range of about 14% to about 35% compared to a single wall scroll. In some embodiments, the sound-dampening housing 14 of the illustrative embodiment provides a noise reduction within a range of about 10% to about 50% compared to a single wall scroll. In other embodiments, the sound-dampening housing 14 provides a noise reduction of greater than 50% compared to a single wall scroll.

1. A scroll for a blower assembly, comprising: a motor-mount plate, and
a housing configured to be coupled to the motor-mount plate to define an interior blower cavity for accommodating a fan, the housing comprising:
an inner wall that partially defines the interior blower cavity, and an
outer wall that is at least partially spaced apart from the inner wall and the interior blower cavity to define a cavity between the inner wall and the outer wall,
wherein the cavity is configured to dampen noise and vibrations generated by operation of the fan.

2. The scroll of claim 1, wherein the sound-dampening housing further includes a sound dampening media located within the sound-dampening cavity.

3. The scroll of claim 2, wherein the sound-dampening media includes at least one of a gas and an insulative filler material.

4. The scroll of claim 1, wherein the housing comprises a base panel and a sidewall panel and the cavity is defined in both the base panel and the sidewall panel.

5. The scroll of claim 1, wherein the motor-mount plate comprises and inner wall and an outer wall and a cavity is defined between the inner wall and the outer wall.
